(19) United States
(12) Patent Application Publication
(10) Pub. No.: US 2019/0368394 A1
(43) Pub. Date: Dec. 5, 2019

(54) OIL AIR SEPARATOR SYSTEM AND METHOD

(71) Applicant: Laszlo Bori, Kitchener (CA)

(72) Inventor: Laszlo Bori, Kitchener (CA)

(21) Appl. No.: 15/993,509

(22) Filed: May 30, 2018

(51) Int. Cl. F01M 13/04; B01D 46/00; B01D 46/10

(52) U.S. Cl. CPC F01M 13/04; B01D 46/0002; B01D 46/10; B01D 46/0009; B01D 2279/60; B01D 2271/027; B01D 2265/029; B01D 2279/35; F01M 2013/0438

(57) ABSTRACT

The oil air separator system is designed to stop oil contaminated air from entering the intake manifold. All engines have a vacuum hose from the valve cover or valley pan connected to the intake manifold. The device serves to evacuate ‘blow by’ from the engine. The contaminated air (with oil vapors) is effectively removed. This prevents oil deposits from being realized inside the intake manifold and on the spark plugs. By removing the dirty air, the engine can breathe ‘clean’ air. The container can hold the oil and water while the filter inside keeps the air clean reducing pollution.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of internal combustion engines of existing art and more specifically relates to gas separation.

### RELATED ART

Many individuals drive vehicles for work and recreation between locations. Many of the vehicles have internal combustion engines to propel them forward and backward. Internal combustion engines deliver contaminated air from the crankcase oil which enters the intake manifold. These engines typically have a vacuum hose from the valve cover or valley pan connected to the intake manifold. The ‘blow by’ from the engine needs to be effectively evacuated. This blow by air is contaminated with oil vapors. The oil deposits inside the intake manifold and the spark plugs. Removing the dirty air would allow the engine to breathe clean air. What is desired is increased engine life, increased efficiency and performance as well as a reduction in air pollution. A suitable solution is desired.

U.S. Pat. No. 6,009,846 to Robert A. Walker, Jr. relates to a combination air-filter/air-oil separator with integral vacuum regulator. The described combination air-filter/air-oil separator with integral vacuum regulator includes a combination apparatus which silences and filters air flow, separates air-contaminant mixtures, and maintains a regulated vacuum therein. An air filter joins an annular housing which has an outer wall and a channel defining a central axis, the channel having a primary gas inlet coupled to the air filter and a primary gas outlet and a channel wall. The apparatus has a secondary inlet port passing through the outer wall. A secondary outlet port defines an opening in the channel wall such that there is no straight line flow path between the secondary inlet and the secondary outlet. An air silencer is contained within the channel. A passageway between the secondary inlet and the secondary outlet is defined exteriorly by the outer wall and interiorly by the channel wall. A vacuum regulating means is disposed within the annular housing and is positioned next to an opening in the secondary outlet to regulate the amount of vacuum imposed within the passageway so that it does not exceed a determined maximum.

### SUMMARY OF THE INVENTION

In view of the foregoing disadvantages inherent in the known internal combustion engine art, the present disclosure provides a novel oil air separator system. The general purpose of the present disclosure, which will be described subsequently in greater detail, is to provide a reliable means to stop oil contaminated air from entering the intake manifold. The device effectively evacuates ‘blow by’ from the engine; the air contaminated with oil vapors is virtually eliminated such that oil is prevented from depositing inside the intake manifold and on the spark plugs. By removing the ‘dirty air’, the engine can breathe clean air. The container holds the oil and water while the filter inside keeps the air clean and thereby reduces pollution.

An oil air separator system is disclosed herein. The oil air separator system includes a canister having a body forming a housing with an inner volume and an outer surface (generally cylindrically shaped); an ingress port; an egress port; a removable filter; and an ingress tube. The housing defines the outer surface enclosing the inner volume via a wall; the ingress port permitting an input-air-solution to enter the ingress tube from an internal combustion engine to pass through to be filtered through the removable filter and passing through the inner volume to the egress port and out to an intake manifold such that the contaminants are removed from the input-air-solution. In this way the (now) clean-filtered-air is able to pass into the intake manifold to increase efficiency in operation and longevity of the internal combustion engine.

According to another embodiment, a method of use for the oil air separator system is also disclosed herein. The method includes installing the device disclosed herein (retro-fit or OEM), using the device to remove contaminates before the air reaches the intake manifold, changing the filter (or cleaning as needed), and servicing as required.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an oil air separator system, constructed and operative according to the teachings of the present disclosure.

FIG. 1 is a top view of the oil air separator system during an ‘in-use’ condition, according to an embodiment of the disclosure.

FIG. 2 is a side view of the oil air separator system (as connected to the internal combustion engine ready for completion of install) of FIG. 1, according to an embodiment of the present disclosure.

FIG. 3 is a perspective view of the oil air separator system of FIG. 1, according to an embodiment of the present disclosure.

FIG. 4 is a perspective view of the top shell and the bottom shell (uncoupled) of the oil air separator system of FIG. 1, according to an embodiment of the present disclosure.

FIG. 5 is a top view of the bottom shell and the ingress tube of the oil air separator system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a filtering means for use with internal combustion engines and more particularly to an oil air separator system and method as used to improve the longevity of engine life and to minimize air pollution.

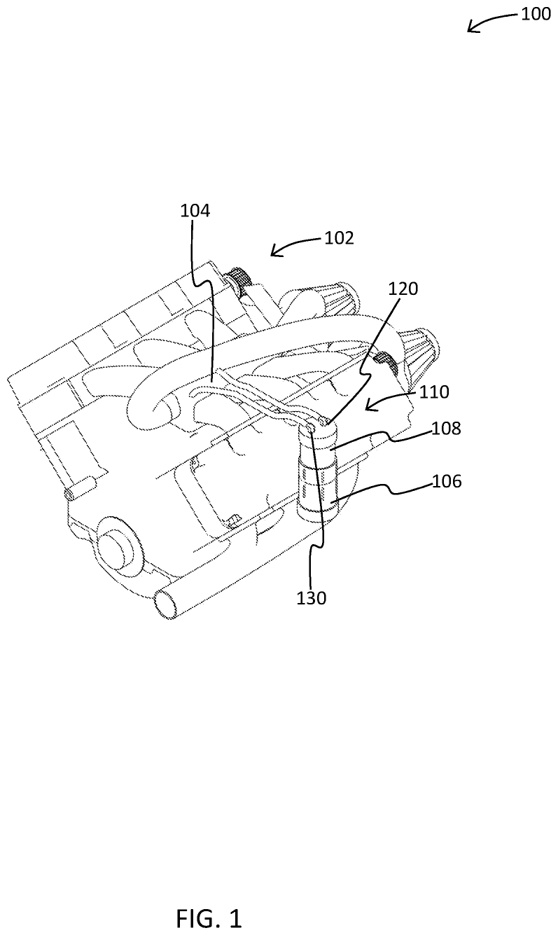

Generally, the present invention serves to promote engine efficiency and reduce pollution by collecting contaminants from the crankcase and prevents them from entering the intake manifold. Referring now more specifically to the drawings by numerals of reference, there is shown in FIGS. 1-5, various views of an oil air separator system 100. FIG. 1 shows an oil air separator system 100 during an ‘in-use’ condition 150, according to an embodiment of the present disclosure. Here, the oil air separator system 100 may be beneficial for use by a user to clean contaminants from the crankcase of the internal combustion engine 102 and prevent them from entering the intake manifold 104 (‘in-use’ condition 150).

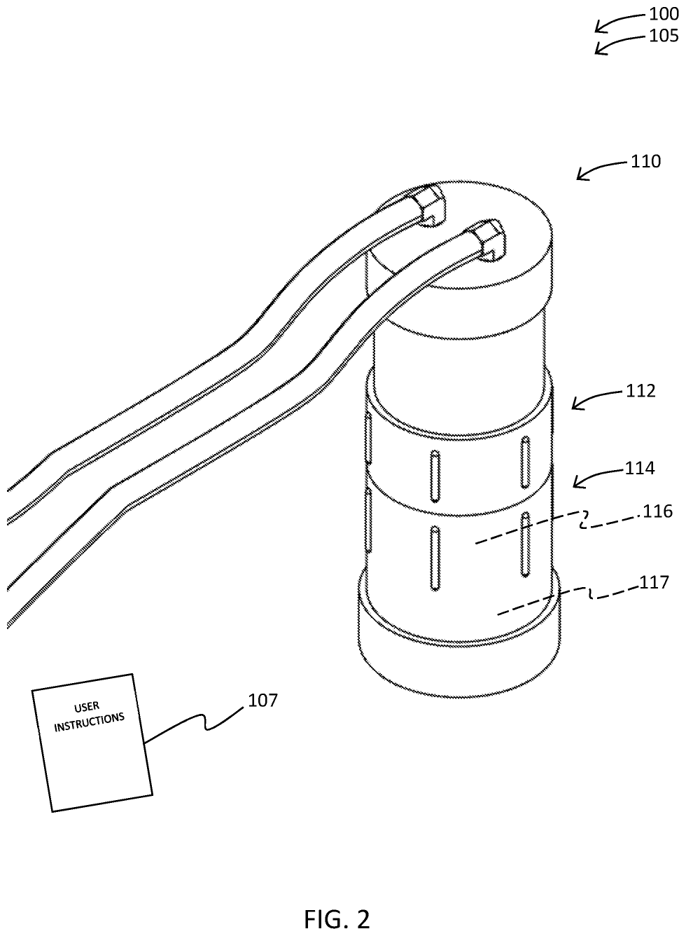

FIGS. 2-5 show respectively, a side view of the oil air separator system 100 (as connected to the internal combustion engine 102 ready for completion of install); a perspective view of the oil air separator system 100; a perspective view of the top shell 108 and the bottom shell 106 (as uncoupled) of the oil air separator system 100 and a top view of the bottom shell 106 and the ingress tube 160 of the oil air separator system 100 of FIG. 1, all according to an embodiment of the present disclosure.

As illustrated, starting with FIG. 1, the oil air separator system 100 may include a canister 110 having a body 112 forming a housing 114 with an inner volume 116 and an outer surface 118; an ingress port 120; an egress port 130; a removable filter 140; and an ingress tube 160. The housing 114 is defined by the outer surface 118 effectively enclosing the inner volume 116; the ingress port 120 permitting an input-air-solution (contaminated air from the crankcase) to enter the ingress tube 160 from the internal combustion engine 102 to pass through a bottom portion 117 before being filtered through the removable filter 140 and passing through the inner volume 116 to the egress port 130 and out to the intake manifold 104 such that the contaminants from the input-air-solution are left in the bottom portion 117. In this way the clean-filtered-air is able to pass into the intake manifold 104 to increase efficiency in operation and longevity of the internal combustion engine 102.

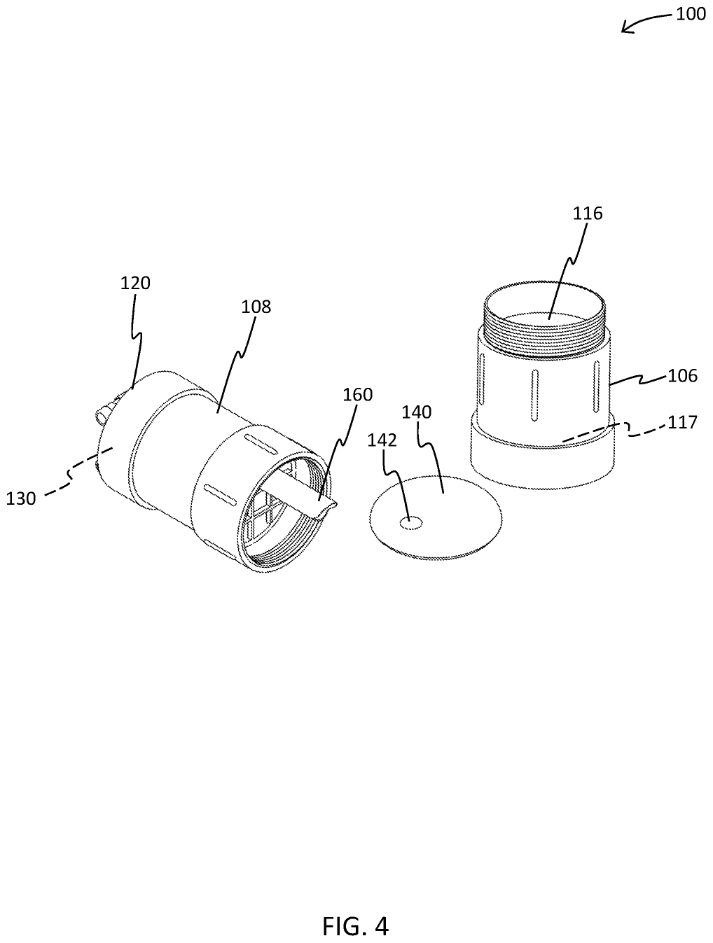

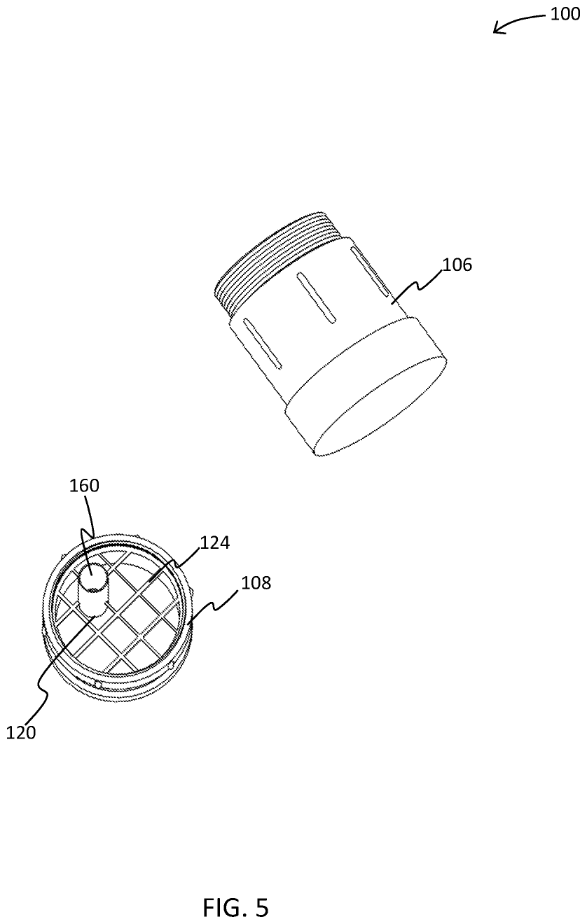

The ingress tube 160 is located in bottom portion 117 during use such that the contaminants flowing through the ingress tube 160 traveling from the crankcase come to rest in the bottom portion 117 are stopped and are contained within the bottom portion 117 for later disposal and not allowed to pass further into the intake manifold 104. This filtration reduces maintenance on the remainder of the system (spark plugs, etc.) of the internal combustion engine 102. The canister 110 comprises a top shell 108 and a bottom shell 106 (comprising bottom portion 117). The top shell 108 and the bottom shell 106 are removably couplable to and from each other via threads (threading as shown in FIGS. 4-5) and an O-ring for sealing; however alternate embodiments may comprise a one-piece construction or other means for coupling).

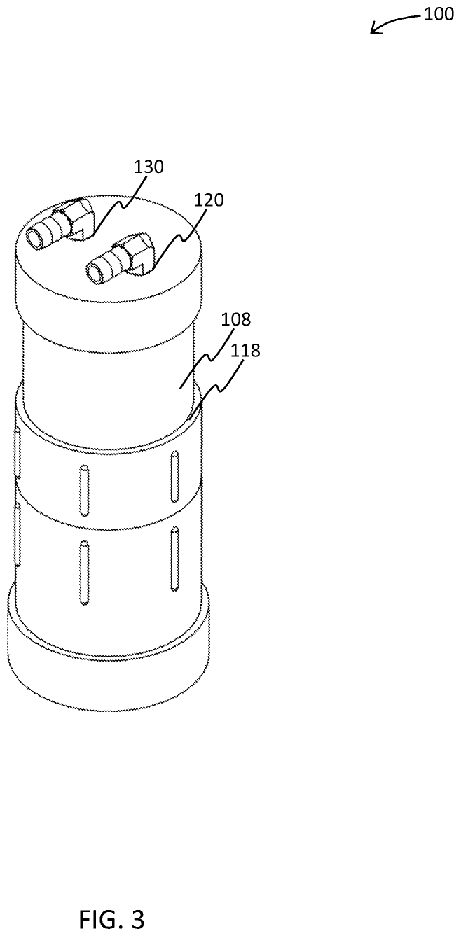

Referring now to the bottom shell 106; the bottom shell 106 comprises a filter shelf 124 such that when the removable filter 140, when placed, is located above the surface of the bottom portion 117 such that oil and other contaminates do not come into contact with the removable filter 140. The ingress port 120 and the egress port 130 pass into the inner volume 116 of the body 112 from the top shell 108; wherein the ingress port 120 and the egress port 130 in preferred embodiments each comprise a respective fitting (90-degree fitting or other may be used as per vehicular specific application for ease of fitting within the engine bay space provided). Each of the respective fittings preferably comprises a barbed-end (FIG. 3) such that the hoses attached thereto are held in stasis during use. Each of the respective fittings are able to connect to a length of hose as shown (FIGS. 1-2), one hose from the crankcase of the internal combustion engine 102 and another connecting to the intake manifold 104.

The bottom shell 106 of the canister 110 of the oil air separator system 100 comprises the bottom portion 117. The top shell 108 and the bottom shell 106 are removably couplable to and from each other, as shown in FIGS. 4-5. The ingress tube 160 (during use) passes through the removable filter 140 and the ingress tube 160 passes through the filter shelf 124. The removable filter 140 comprises an aperture 142 allowing the ingress tube 160 to pass through the removable filter 140; wherein the removable filter 140 comprises a mesh 144 suitable to collect contaminates. The removable filter 140 is able to be replaced or cleaned. The ingress tube 160 comprises suitable material that resists degradation when contacting contaminates (such as oil) such that a sufficient longevity of use for the oil air separator system 100 is achieved. The bottom shell 106 and the top shell 108 may have an O-ring placed between them to promote sealing of the canister 110.

Removable filter 140 comprises mesh 144 comprising a particulate air filter composed of fibrous or porous materials which removes solid particulates such as dust, pollen, and the like from the air. Removable filter 140 may contain an absorbent or catalyst such as charcoal (carbon) to remove odors and gaseous pollutants in alternate embodiments. In certain embodiments foam, pleated paper, cotton filters, or spun fiberglass filter elements may be used. Those with ordinary skill in the art will now appreciate that upon reading this specification and by their understanding the art of filters as described herein, methods of filtration will be understood by those knowledgeable in such art.

According to one embodiment, the oil air separator system 100 may be arranged as a kit 105. In particular, the oil air separator system 100 may further include a set of instructions 107. The instructions 107 may detail functional relationships in relation to the structure of the oil air separator system 100 such that the oil air separator system 100 can be installed, used, maintained, or the like, in a preferred manner.

A method of use includes steps of: installing the device disclosed herein (retro-fit or OEM), using the device to remove contaminates before the air reaches the intake manifold, changing the filter (or cleaning as needed), and servicing as required. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use of the oil air separator system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An oil air separator system, the system comprising:
a canister having
a body forming a housing with an inner volume and an outer surface;
an ingress port;
an egress port;
a removable filter; and
an ingress tube;
wherein said housing is defined by said outer surface enclosing said inner volume, said ingress port permits an input-air-solution to enter said ingress tube from an internal combustion engine to pass into a bottom of said body before being filtered through said removable filter and passing through said inner volume to said egress port and out to an intake manifold such that contaminants are removed from said input-air-solution such that clean-filtered-air is able to pass into said intake manifold to increase efficiency in operation and longevity of said internal combustion engine.

2. The oil air separator system of claim 1, wherein said ingress tube is open during use.

3. The oil air separator system of claim 1, wherein said canister comprises a top shell and a bottom shell.

4. The oil air separator system of claim 1, wherein said top shell and said bottom shell are removably couplable to and from each other via threads and an O-ring used for sealing together.

5. The oil air separator system of claim 1, wherein said bottom shell comprises a filter shelf such that when said removable filter, when placed, is located above said bottom shell such that said contaminates do not contact said removable filter.

6. The oil air separator system of claim 1, wherein said ingress port and said egress port pass into said inner volume of said body from said top shell.

7. The oil air separator system of claim 1, wherein said ingress port and said egress port each comprise a respective fitting.

8. The oil air separator system of claim 1, wherein each said respective fitting comprises a barbed-end.

9. The oil air separator system of claim 1, wherein each of said respective fittings are able to connect to a length of hose.

10. The oil air separator system of claim 1, wherein said bottom shell comprises a collection place for said contaminates that can be discarded of during a non-use period.

11. The oil air separator system of claim 1, wherein said top shell and said bottom shell are removably couplable to and from each other.

12. The oil air separator system of claim 1, wherein said ingress tube passes through said removable filter.

13. The oil air separator system of claim 1, wherein said ingress tube passes through said filter shelf.

14. The oil air separator system of claim 1, wherein said removable filter comprises an aperture allowing said ingress tube to pass through said removable filter.

15. The oil air separator system of claim 1, wherein said removable filter comprises a mesh.

16. The oil air separator system of claim 1, wherein said ingress tube comprises material that resists degradation when contacting oil and said contaminates.

17. An oil air separator system for use with an internal combustion engine, the system comprising:
a canister having; a body forming a housing with an inner volume and an outer surface; an ingress port; an egress port; a removable filter; and an ingress tube; wherein said housing defines said outer surface enclosing said inner volume, said ingress port permitting an input-air-solution to enter said ingress tube from an internal combustion engine to pass through being filtered through said removable filter and passing through said inner volume to said egress port and out to an intake manifold such that contaminants are removed from said input-air-solution such that clean-filtered-air is able to pass into said intake manifold to increase efficiency in operation and longevity of said internal combustion engine;
wherein said canister comprises a top shell and a bottom shell;
wherein said top shell and said bottom shell are removably couplable to and from each other via threads;
wherein said ingress port and said egress port pass into said inner volume of said body from said top shell;
wherein said ingress port and said egress port each comprise a respective fitting;
wherein each said respective fitting comprises a barbed-end;
wherein each of said respective fittings are able to connect to a length of hose;
wherein said top shell and said bottom shell are removably couplable to and from each other;
wherein said ingress tube passes through said removable filter;
wherein said ingress tube passes through said filter shelf;
wherein said removable filter comprises an aperture allowing said ingress tube passes through said removable filter;
wherein said removable filter comprises a mesh.

18. The oil air separator system of claim 17, further comprising a set of instructions; and
wherein the oil air separator system is arranged as a kit.
